(19) United States
(12) Patent Application Publication
(10) Pub. No.: US 2025/0336949 A1
(43) Pub. Date: Oct. 30, 2025

(54) Cathode Active Material for Lithium Secondary Battery, Method of Preparing the Same and Lithium Secondary Battery Including the Same

(71) Applicant: SK On Co., Ltd., Seoul (KR)

(72) Inventors: Ji Hye JANG, Daejeon (KR); Hee Jun KWEON, Daejeon (KR); Ji Hoon CHOI, Daejeon (KR)

(21) Appl. No.: 19/188,119

(22) Filed: Apr. 24, 2025

(30) Foreign Application Priority Data
Apr. 24, 2024 (KR) 10-2024-0054722

(51) Int. Cl. H01M 4/36; C01G 53/42; H01M 4/525; H01M 4/587; H01M 10/052

(52) U.S. Cl. CPC H01M 4/366; C01G 53/42; H01M 4/525; H01M 4/587; H01M 10/052; C01P 2002/54; C01P 2004/03; C01P 2004/80; C01P 2006/40

(57) ABSTRACT

A cathode active material for a lithium secondary battery according to the embodiments of the present disclosure includes composite particles including lithium-transition metal oxide particles, a carbon coating disposed on the lithium-transition metal oxide particles, and a carbon nanotube (CNT) coating formed on the carbon coating, wherein a content of the CNT coating measured through thermogravimetric analysis (TGA) is 0.8% by weight to 3.1% by weight based on the total weight of the composite particles.

### CROSS-REFERENCE TO RELATED APPLICATION AND CLAIM OF PRIORITY

This application claims priority to Korean Patent Applications No. 10-2024-0054722 filed on Apr. 24, 2024 in the Korean Intellectual Property Office (KIPO), the entire disclosure of which is incorporated by reference herein.

### BACKGROUND

### 1. Field of the Invention

The disclosure of the present application relates to a cathode active material for a lithium secondary battery, a method of preparing the same, and a lithium secondary battery including the cathode active material.

### 2. Description of the Related Art

A secondary battery is a battery that can be repeatedly charged and discharged. With rapid progress of information and communication technology and display industries, the secondary battery has been widely applied to various portable electronic telecommunication devices such as a camcorder, a mobile phone, a laptop computer as a power source thereof. Recently, a battery pack including the secondary battery has also been developed and applied to an eco-friendly automobile such as an electric vehicle, a hybrid vehicle, etc., as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

As the applications of lithium secondary batteries have recently expanded, longer cycle life (lifespan), high capacity and operational stability are required. For example, the capacity characteristics and cycle life characteristics of the lithium secondary battery may deteriorate depending on the structure of the cathode active material of the lithium secondary battery, and the presence or absence of a conductive material bonded thereto.

### SUMMARY

According to an aspect of the present disclosure, a cathode active material for a lithium secondary battery having improved capacity characteristics and cycle life characteristics may be provided.

According to another aspect of the present disclosure, a method of preparing a cathode active material for a lithium secondary battery having improved capacity characteristics and cycle life characteristics may be provided.

In addition, according to another aspect of the present disclosure, a lithium secondary battery, which includes the cathode active material and exhibits improved capacity characteristics and cycle life characteristics, may be provided.

A cathode active material for a lithium secondary battery according to exemplary embodiments of the present disclosure includes: lithium-transition metal oxide particles; a carbon coating disposed on the lithium-transition metal oxide particles; and composite particles including a carbon nanotube (CNT) coating formed on the carbon coating. A content of the CNT coating measured through thermogravimetric analysis (TGA) is 0.8% by weight to 3.1% by weight based on a total weight of the composite particles.

In some embodiments, the content of the CNT coating may be 1.23% by weight to 2.51% by weight based on the total weight of the composite particles.

In some embodiments, the carbon coating may be derived from polydopamine.

In some embodiments, the lithium-transition metal oxide particles may include nickel, and a molar ratio of nickel included in the lithium-transition metal oxide particles based on the total number of moles of metals excluding lithium in the lithium-transition metal oxide particles may be 0.8 or more.

A lithium secondary battery according to exemplary embodiments of the present disclosure includes: the cathode including the above-described cathode active material for a lithium secondary battery; and an anode disposed to face the cathode.

According to a method of preparing a cathode active material for a lithium secondary battery of exemplary embodiments of the present disclosure, lithium-transition metal oxide particles may be prepared. The lithium-transition metal oxide particles may be mixed with a dopamine compound in an amount of 6 mol % to 19 mol % based on the number of moles of the lithium-transition metal oxide particles to form preliminary composite particles including a polydopamine coating formed on the lithium-transition metal oxide particles. A mixture of the preliminary composite particles and carbon nanotubes (CNTs) may be formed. The mixture may be calcined to prepare composite particles including a carbon coating formed on the lithium-transition metal oxide particles and a CNT coating formed on the carbon coating. A content of the CNT coating measured through thermogravimetric analysis (TGA) may be 0.8% by weight to 3.1% by weight based on a total weight of the composite particles.

In some embodiments, covalent bonds may be formed between the polydopamine coating and the CNTs in the mixture of the preliminary composite particles and the CNTs.

In some embodiments, the polydopamine coating may be carbonized during the calcination to form the carbon coating.

In some embodiments, the calcination may be performed at 400° C. to 800° C.

In some embodiments, the dopamine compound may include dopamine hydrochloride.

In some embodiments, a content of the dopamine compound mixed with the lithium-transition metal oxide particles may be 8 mol % to 15 mol % based on the number of moles of the lithium-transition metal oxide particles.

In some embodiments, the content of the CNT coating may be calculated by subtracting the carbon content of the preliminary composite particles measured through TGA from the carbon content of the composite particles measured through TGA.

In some embodiments, the lithium-transition metal oxide particles may be formed by reacting a lithium precursor with a transition metal precursor.

According to an embodiment of the present disclosure, when the carbon nanotube (CNT) coating is formed in a sufficient amount, the mobility of lithium ions may be improved. Accordingly, the cycle life characteristics, power characteristics, and initial capacity of the secondary battery may be enhanced.

According to an embodiment of the present disclosure, when a sufficient amount of CNTs are bonded to the polydopamine coating, an excessive increase in the thickness of the CNT coating may be suppressed. Accordingly, the cycle life characteristics, power characteristics, and initial capacity characteristics of the battery may be enhanced.

According to an embodiment of the present disclosure, the CNTs may be uniformly dispersed and bonded to the surface of the composite particles. Accordingly, the electrical conductivity and cycle life characteristics of the battery may be improved.

The cathode active material for a lithium secondary battery of the present disclosure and the lithium secondary battery including the same may be widely applied in green technology fields, such as electric vehicles, battery charging stations, as well as solar power generation, wind power generation, and the like, which use the batteries. The cathode active material for a lithium secondary battery of the present disclosure and the lithium secondary battery including the same may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart for describing processes of a method of preparing a cathode active material for a lithium secondary battery according to exemplary embodiments;

FIGS. 2 and 3 are a schematic plan view and a cross-sectional view of the lithium secondary battery according to exemplary embodiments, respectively;

FIGS. 4 and 5 are field emission scanning electron microscope (FE-SEM) images of lithium-transition metal oxide particles according to Example 1, respectively;

FIGS. 6 and 7 are FE-SEM images of preliminary composite particles according to Example 1, respectively; and

FIG. 8 is an FE-SEM image of the composite particles according to Example 1.

### DETAILED DESCRIPTION OF THE EMBODIMENTS

Examples according to the disclosure of the present application provide a cathode active material for a lithium secondary battery (hereinafter, may be abbreviated as a “cathode active material”). In addition, a method for preparing the cathode active material and a lithium secondary battery (hereinafter, may be abbreviated as “secondary battery”) including the cathode active material are provided.

Hereinafter, the embodiments of the present disclosure will be described in detail. However, these embodiments are merely examples, and the present disclosure is not limited to the specific embodiments described as the example.

In exemplary embodiments, the cathode active material includes composite particles including lithium (Li)-transition metal oxide particles.

According to exemplary embodiments, the lithium-transition metal oxide particles may include a lithium-nickel (Ni) metal oxide. The lithium-nickel metal oxide may further include at least one of cobalt (Co), manganese (Mn) and aluminum (Al).

In some embodiments, the lithium-nickel metal oxide particles may include a layered structure or a crystal structure represented by Formula 1 below.

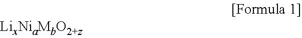

In Formula 1, x, a, b and z may satisfy 0.9≤x≤1.2, 0.6≤a≤0.99, 0.01≤b≤0.4, −0.5≤z≤0.1. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing introduction and substitution of the additional elements.

In one embodiment, the cathode active material may further include auxiliary elements which are added to the main active elements, thus to enhance chemical stability thereof or the layered structure/crystal structure. The auxiliary element may be incorporated into the layered structure/crystal structure together to form a bond, and it should be understood that this case is also included within the chemical structure range represented by Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may act as an auxiliary active element which contributes to the capacity/power activity of the cathode active material together with Co or Mn like Al.

For example, the cathode active material or the lithium-nickel metal oxide particles may include a layered structure or crystal structure represented by Formula 1-1 below.

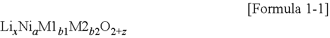

In Formula 1-1, M1 may include Co, Mn and/or Al. M2 may include the above-described auxiliary elements. In Formula 1-1, x, a, b1, b2 and z may satisfy 0.9≤x≤1.2, 0.6≤a≤0.99, 0.01≤b1+b2≤0.4, −0.5≤z≤0.1.

The composite particle may further include a doping element. For example, elements which are substantially the same as or similar to the above-described auxiliary elements may be used as the doping element. For example, the above-described elements may be used alone or in combination of two or more thereof.

The doping element may be present on the surface of the lithium-nickel metal oxide particles, or may penetrate through the surface of the lithium-nickel metal oxide particles to become incorporated into the bonding structure represented by Formula 1 or Formula 1-1 above.

In some embodiments, the lithium-nickel metal oxide particles may include a nickel-cobalt-manganese (NCM)-based lithium oxide. In this case, an NCM-based lithium oxide with an increased nickel content may be used.

Nickel may be provided as a transition metal associated with the power and capacity of the lithium secondary battery. Therefore, as described above, by employing a high-content (High-Ni) composition in the cathode active material, a high-capacity cathode and a high-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity.

A content of Ni in the lithium-transition metal oxide particles (for example, a ratio of the number of moles of nickel in the lithium-transition metal oxide particles to the total number of moles of metals excluding lithium in the lithium-transition metal oxide particles) may be 0.5 or more, 0.6 or more, 0.7 or more, 0.8 or more, or 0.9 or more. In some embodiments, the content of Ni may be 0.8 to 0.98, 0.82 to 0.98, 0.83 to 0.98, 0.84 to 0.98, 0.85 to 0.98, 0.88 to 0.98, or 0.9 to 0.98. When the Ni content is 0.8 or more, the capacity characteristics and the power characteristics of the battery may be improved.

In some embodiments, the cathode active material may also include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a lithium (Li) rich layered oxide (LLO)/over lithiated oxide (OLO)-based active material, a manganese (Mn)-rich active material, or a cobalt (Co)-less active material, etc., having a chemical structure or crystal structure represented by Formula 2 below. These may be used alone or in combination of two or more thereof.

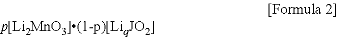

In Formula 2, p and q may satisfy 0<p<1, 0.9≤q≤1.2, and J may include at least one element selected from the group consisting of Mn, Ni, Co, Fe, Cr, V, Cu, Zn, Ti, Al, M, and B.

For example, the lithium-transition metal oxide particles may include secondary particles formed by aggregation of a plurality of primary particles.

According to exemplary embodiments, the composite particles include a carbon coating disposed on the lithium-transition metal oxide particles. Accordingly, the cycle life characteristics and power characteristics of the secondary battery may be improved.

According to exemplary embodiments, the composite particles may include a carbon nanotube (CNT) coating formed on the carbon coating. The CNT coating may be formed on the lithium-transition metal oxide particles and at least a portion of the surface of the carbon coating. Accordingly, the power characteristics and cycle life characteristics of the battery may be improved.

For example, the CNT coating may be provided as a conductive material to enhance conductivity within the cathode.

The carbon coating may be derived from polydopamine. For example, the carbon coating may be formed by carbonization of a polydopamine coating. In this case, a sufficient amount of CNT coating may be uniformly formed by covalent bonds (pi (π) bonds) between the polydopamine and the CNTs.

In exemplary embodiments, the content of the CNT coating measured through thermogravimetric analysis (TGA) may be 0.8% by weight (“wt %”) to 3.1 wt % based on a total weight of the composite particles, and in some embodiments, 1.23 wt % to 2.51 wt %. Within the above range, the mobility of lithium ions may be improved as the CNT coating is formed in a sufficient amount. Accordingly, the cycle life characteristics, power characteristics, and initial capacity of the secondary battery may be improved.

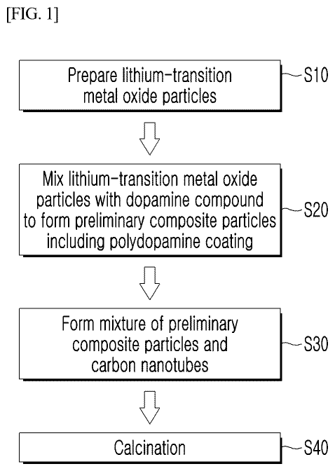

FIG. 1 is a flowchart for describing processes of a method of preparing a cathode active material for a lithium secondary battery according to exemplary embodiments. Hereinafter, a method of preparing the above-described composite particles will be described with reference to FIG. 1.

Referring to FIG. 1, lithium-transition metal oxide particles may be prepared (e.g., step S10).

For example, a mixture of a lithium precursor and a transition metal precursor may be subjected to heat treatment to prepare lithium-transition metal oxide particles.

The transition metal precursor (e.g., Ni—Co—Mn precursor) may be prepared by a co-precipitation reaction.

For example, the transition metal precursor may be prepared by a co-precipitation reaction of metal salts. The metal salts may include nickel salts, manganese salts, and/or cobalt salts.

The nickel salt may include nickel sulfate, nickel hydroxide, nickel nitrate, nickel acetate, a hydrate thereof, etc. Examples of the manganese salt may include manganese sulfate, manganese acetate, a hydrate thereof, etc. Examples of the cobalt salt may include cobalt sulfate, cobalt nitrate, cobalt carbonate, a hydrate thereof, etc. These may be used alone or in combination of two or more thereof.

The metal salts may be mixed with a precipitant and/or a chelating agent in a ratio satisfying the content or concentration ratio of each metal described with reference to Formula 1 and/or Formula 1-1 to prepare an aqueous solution. The aqueous solution may be subjected to a co-precipitation reaction in a reactor to prepare a transition metal precursor.

The precipitant may include an alkaline compound such as sodium hydroxide (NaOH), sodium carbonate (Na₂CO₃), etc. The chelating agent may include, for example, ammonium hydroxide (e.g., NH₄OH), ammonium carbonate (e.g., (NH₄)₂CO₃), etc.

For example, the co-precipitation reaction may be performed at a temperature of about 40° C. to 60° C. for about 24 hours to 72 hours.

The lithium precursor compound may include lithium carbonate, lithium nitrate, lithium acetate, lithium oxide, lithium hydroxide, etc. These may be used alone or in combination of two or more thereof.

The heat treatment may be performed at about 600° C. to 1000° C. for 6 hours to 15 hours. Within the above temperature and time ranges, lithium-transition metal oxide particles may be formed with a stable structure.

In exemplary embodiments, the lithium-transition metal oxide particles may be mixed with the dopamine compound to form preliminary composite particles including a polydopamine coating formed on the lithium-transition metal oxide particles (e.g., step S20).

A content of the dopamine compound is 6 mol % to 19 mol % based on the number of moles of the lithium-transition metal oxide particles, and in some embodiments, 8 mol % to 15 mol %. Within the above range, a sufficient amount of CNTs may be bonded to the polydopamine coating, thereby suppressing an excessive increase in the thickness of the CNT coating. Accordingly, the cycle life characteristics, power characteristics, and initial capacity characteristics of the battery may be enhanced.

According to an embodiment, the dopamine compound may include dopamine hydrochloride.

For example, the dopamine compound may be attached to the lithium-transition metal oxide particles with a strong bonding force, and may be oxidized and polymerized to form a polydopamine coating.

For example, the dopamine compound may be dissolved in a solvent (e.g., pure water) to prepare a dopamine solution, and lithium-transition metal oxide particles may be introduced into the dopamine solution and stirred to form a cake. The cake may be washed with water and/or alcohol (e.g., ethanol) and dried to form a polydopamine coating on the surface of the lithium-transition metal oxide particles.

For example, the drying may be performed at 40° C. to 80° C.

In exemplary embodiments, the preliminary composite particles and CNTs may be mixed to form a mixture (e.g., step S30).

According to some embodiments, covalent bonds may be formed between the polydopamine coating and the CNTs in the mixture.

For example, a strong pi-pi (π-π) bond may be formed between an aromatic dopamine of the polydopamine coating and a graphite framework of the CNTs. The pi-pi bond may represent a pi-pi interaction. Due to the pi-pi bond, the CNTs, which tend to agglomerate, may be uniformly dispersed and bonded to the surface of the preliminary composite particle.

In some embodiments, the content of the CNTs may be about 3 wt % to 5 wt % based on the total weight of the preliminary composite particles.

For example, CNTs may be added to a solvent (e.g., distilled water) and dispersed to prepare a CNT solution. Then, the preliminary composite particles may be introduced into the CNT solution and mixed.

In exemplary embodiments, the mixture of the preliminary composite particles and the CNTs may be subjected to calcination to form composite particles including a carbon coating formed on the lithium-transition metal oxide particles and a CNT coating formed on the carbon coating (e.g., step S40).

The polydopamine coating may be carbonized during the calcination to form a carbon coating on the lithium-transition metal oxide particles. By forming the polydopamine coating prior to the CNT mixing, a sufficient amount of CNTs may be uniformly bonded to the surface of the preliminary composite particles. Subsequently, the carbon coating and the CNT coating may be formed during the calcination, thereby improving the electrical conductivity and cycle life characteristics of the battery.

The calcination may be performed at about 400° C. to 800° C., and in some embodiments, at about 500° C. to 800° C. Within the above range, the polydopamine coating may be carbonized to form a carbon coating, and a CNT coating may be formed on the carbon coating.

For example, the calcination may be performed under an oxygen atmosphere or an inert atmosphere.

In some embodiments, the solvent of the CNT solution may be dried prior to the calcination of the mixture. The drying may be performed at about 80° C. to 120° C.

The content of the CNT coating in the composite particles prepared by the above-described method, as measured through TGA, is 0.8 wt % to 3.1 wt % based on the total weight of the composite particle.

In some embodiments, the content of the CNT coating may be determined as a value obtained by subtracting the carbon content of the preliminary composite particles measured through TGA from the carbon content of the composite particles measured through TGA.

For example, a sample of the composite particles may be introduced into TGA, heated to 800° C., and a first mass loss may be measured. Then, a sample of the preliminary composite particles may be introduced into the TGA, heated to 800° C., and a second mass loss may be measured.

The first mass loss may correspond to the sum of the contents of the pyrolyzed carbon coating and the CNT coating, and the second mass loss may correspond to the content of the pyrolyzed carbon coating.

The content of the CNT coating may be calculated by subtracting the second mass loss from the first mass loss.

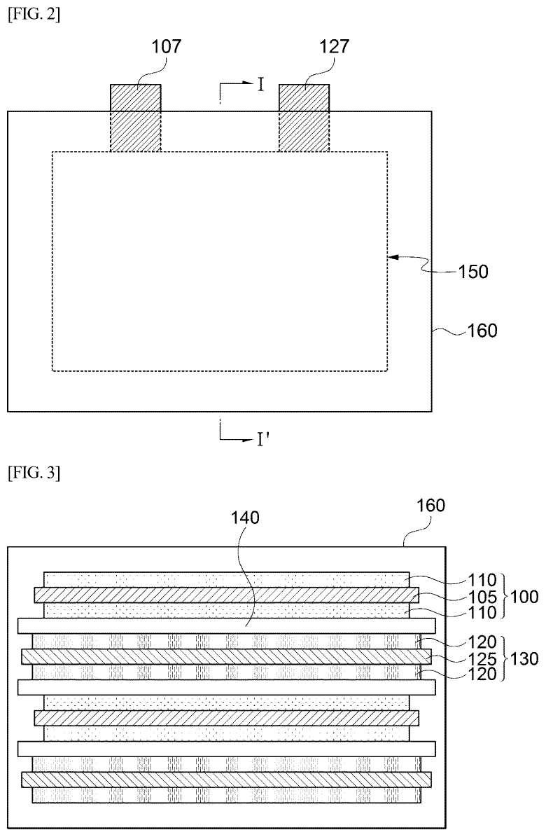

FIGS. 2 and 3 are a schematic plan view and a cross-sectional view illustrating a lithium secondary battery according to exemplary embodiments, respectively. For example, FIG. 3 is a cross-sectional view taken on line I-I′ in FIG. 2 in a thickness direction of the battery.

The lithium secondary battery may include a cathode 100 including the above-described cathode active material and an anode 130 disposed to face the cathode 100.

The cathode 100 may include a cathode current collector 105, and a cathode active material layer 110 formed on at least one surface of the cathode current collector 105.

The cathode current collector 105 may include stainless steel, nickel, aluminum, titanium or an alloy thereof. The cathode current collector 105 may also include aluminum or stainless steel subjected to surface treatment with carbon, nickel, titanium or silver. For example, the cathode current collector 105 may have a thickness of 10 to 50 μm.

The cathode active material layer 110 may include the above-described cathode active material. The cathode active material may include a plurality of the above-described composite particles.

The content of the composite particles may be 50 wt % or more based on the total weight of the cathode active material. In some embodiments, the content of the composite particles may be 60 wt % or more, 70 wt % or more, 80 wt % or more, or 90 wt % or more based on the total weight of the cathode active material.

In one embodiment, the cathode active material may substantially consist of composite particles.

The cathode active material may be mixed in a solvent to prepare a cathode slurry. The cathode slurry may be applied to at least one surface of the cathode current collector 105, followed by drying and pressing the same to prepare the cathode active material layer 110. The coating may include a method such as gravure coating, slot die coating, simultaneous multilayer die coating, imprinting, doctor blade coating, dip coating, bar coating or casting. The cathode active material layer 110 may further include a binder, and optionally further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may decrease and the amount of the cathode active material may relatively increase. Accordingly, the power characteristics and capacity characteristics of the secondary battery may be improved.

In addition to the above-described CNTs, other conductive materials may be further included. For example, the conductive material may be added to the cathode active material layer 110 in order to enhance the conductivity thereof and/or the mobility of lithium ions or electrons. For example, the conductive material may further include, in addition to the CNTs, a carbon-based conductive material such as graphite, carbon black (e.g., Denka Black), acetylene black, Ketjen black, graphene, vapor-grown carbon fibers (VGCFs), carbon fibers, etc., and/or a metal-based conductive material including tin, tin oxide, titanium oxide, or a perovskite material such as LaSrCoO₃, and LaSrMnO₃. These may be used alone or in combination of two or more thereof.

The cathode slurry may further include a thickener and/or a dispersant. In one embodiment, the cathode slurry may include a thickener such as carboxymethyl cellulose (CMC).

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more. For example, the anode current collector 125 may have a thickness of 10 μm to 50 μm.

The anode active material layer 120 may include an anode active material. A material capable of intercalating and deintercalating lithium ions may be used as the anode active material. For example, the anode active material may include crystalline carbon-based materials such as crystalline carbon, amorphous carbon, a carbon composite, or carbon fibers, etc.; lithium metal; a lithium alloy; a silicon (Si)-containing material or a tin (Sn)-containing material, etc. These may be used alone or in combination of two or more thereof.

The amorphous carbon may include hard carbon, soft carbon, cokes, mesocarbon microbead (MCMB), mesophase pitch-based carbon fiber (MPCF) or the like.

The crystalline carbon may include graphite-based carbon such as natural graphite, artificial graphite, graphite cokes, graphite MCMB, graphite MPCF or the like.

The lithium metal may include pure lithium metal and/or lithium metal having a protective layer formed thereon for suppressing dendrite growth and the like. In one embodiment, a lithium metal-containing layer deposited or applied to the anode current collector 125 may also be used as the anode active material layer 120. In one embodiment, a lithium thin film layer may also be used as the anode active material layer 120.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity characteristics. The silicon-containing material may include Si, SiOₓ (0<x<2), metal-doped SiOₓ (0<x<2), a silicon-carbon composite, etc.

The metal may include lithium and/or magnesium, and the metal-doped SiOₓ (0<x<2) may include a metal silicate.

The anode active material may be mixed in a solvent to prepare an anode slurry. The anode slurry may be applied/deposited to the anode current collector 125, followed by drying and pressing the same to prepare the anode active material layer 120. The coating may include a method such as gravure coating, slot die coating, simultaneous multilayer die coating, imprinting, doctor blade coating, dip coating, bar coating or casting, etc. The anode active material layer 120 may further include a binder, and optionally further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when manufacturing the cathode 100 as the binder, conductive material and thickener may be used.

In some embodiments, a styrene-butadiene rubber (SBR)-based binder, carboxymethyl cellulose (CMC), polyacrylic acid-based binder, poly(3,4-ethylenedioxythiophene, PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow a flow of ions to occur. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers and the like.

The separation membrane 140 may also include a ceramic-based material. For example, inorganic particles may be applied to the polymer film or dispersed within the polymer film to improve heat resistance.

The separation membrane 140 may have a single-layer or multi-layer structure including the above-described polymer film and/or non-woven fabric.

According to exemplary embodiments, an electrode cell is defined by the cathode 100, the anode 130 and the separation membrane 140, and a plurality of electrode cells are stacked to form, for example, a jelly roll type electrode assembly 150. For example, the electrode assembly 150 may be formed by winding, stacking, z-folding, stack-folding, etc. the separation membrane 140.

The electrode assembly 150 may be housed in a case 160 together with the electrolyte to define a lithium secondary battery. According to exemplary embodiments, a non-aqueous electrolyte may be used as the electrolyte.

The non-aqueous electrolyte includes a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, and propylene sulfite, and the like may be used. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis-oxalato phosphate, lithium difluoro phosphate, etc.

The borate compound may include lithium bis(oxalate) borate, etc.

In some embodiments, a solid electrolyte may also be used instead of the above-described non-aqueous electrolyte. In this case, the lithium secondary battery may be manufactured in the form of an all-solid-state battery. In addition, a solid electrolyte layer may also be disposed between the cathode 100 and the anode 130 instead of the above-described separation membrane 140.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li2O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q} (p and q are positive numbers, M is P, Si, Ge, B, Al, Ga or In), Li₇-xPS₆-xClₓ (0≤x≤2), Li₇-xPS₆-xBrₓ (0≤x≤2), Li₇-xPS₆-xIₓ (0≤x≤2), etc. These may be used alone or in combination of two or more thereof.

In one embodiment, the solid electrolyte may also include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

As shown in FIGS. 2 and 3, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case 160 to form electrode leads (a cathode lead 107 and an anode lead 127) extending or exposed to an outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### (1) Preparation of Composite Particles

### 1) Preparation of Lithium-Transition Metal Oxide Particles (Step S10)

NiSO₄, CoSO₄ and MnSO₄ were introduced and mixed in a molar ratio of 0.88:0.09:0.03 in distilled water, from which dissolved oxygen had been removed by bubbling N₂ for 24 hours, to prepare a mixed solution. The mixture was introduced into a reactor at 55° C., and a co-precipitation reaction was performed for 36 hours using NaOH and NH₃H₂O as a precipitant and a chelating agent, to obtain Ni_{0.88}Co_{0.09}Mn_{0.03}(OH)₂ as a transition metal precursor. The transition metal precursor was dried at 80° C. for 12 hours, and then additionally dried at 110° C. for 12 hours.

Lithium hydroxide and the transition metal precursor were added to a dry high-speed mixer in a ratio of 1.05:1, and uniformly mixed for 5 minutes. The mixture was put into a calcination furnace in an oxygen atmosphere, heated to 670° C. at a heating rate of 2° C./min, then maintained at 670° C. for 5 hours. Oxygen was continuously supplied at a flow rate of 20 L/min during the heating and calcination. After completion of the calcination, the mixture was naturally cooled to room temperature, and then subjected to pulverization and classification to obtain lithium-transition metal oxide particles (mean particle diameter (D50): 10 μm) represented by LiNi_{0.88}Co_{0.09}Mn_{0.03}O₂.

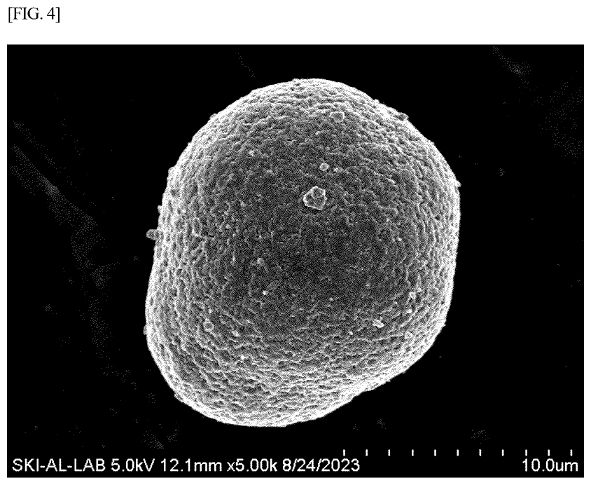

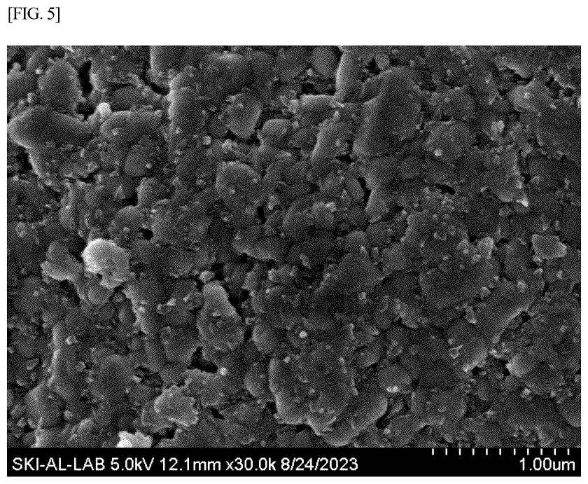

FIGS. 4 and 5 are field emission-scanning electron microscope (FE-SEM) images of the lithium-transition metal oxide particles according to Example 1, respectively. FIG. 5 is an enlarged view of FIG. 4.

2) Formation of Preliminary Composite Particles (Step S20) 10 mol % of dopamine hydrochloride based on the number of moles of the lithium-transition metal oxide particles was introduced into distilled water to prepare a dopamine solution.

The lithium-transition metal oxide particles and tris(hydroxymethyl)aminomethane as a pH adjuster were added to the dopamine solution, and the resulting mixture was stirred at pH 8.5 for 30 minutes.

The cake recovered from the dopamine solution was washed several times with pure water and ethanol using a centrifuge and dried in an oven set at 60° C. to form preliminary composite particles in which a polydopamine coating was formed on the lithium-transition metal oxide particles.

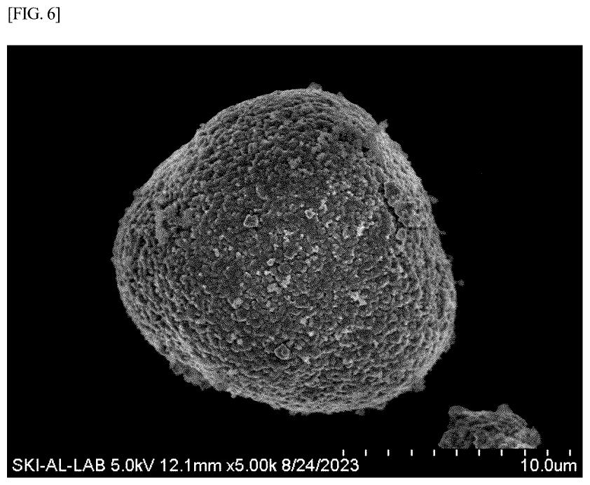

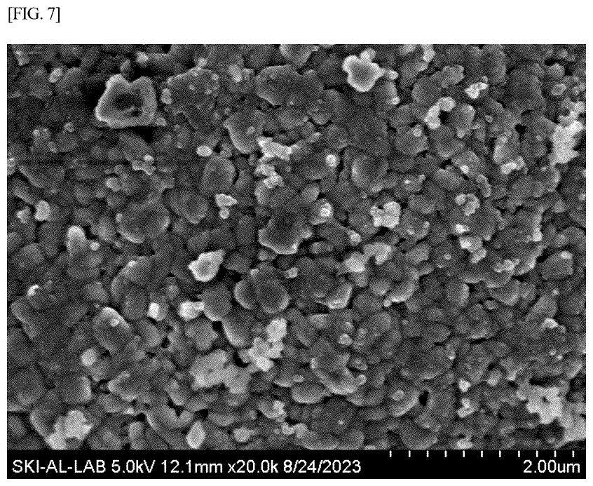

FIGS. 6 and 7 are FE-SEM images of preliminary composite particles according to Example 1, respectively. FIG. 7 is an enlarged view of FIG. 6.

Referring to FIGS. 6 and 7, a polydopamine coating was formed on the lithium-transition metal oxide particles.

### 3) Mixing of Preliminary Composite Particles and Carbon Nanotubes (CNTs) (Step S30)

CNTs, in an amount of 4 wt % based on the weight of the preliminary composite particles, were added to distilled water to prepare a CNT solution, and the CNTs in the CNT solution were dispersed for 30 minutes using an ultrasonic disperser.

The preliminary composite particles were added to the CNT solution, followed by drying and stirring at 100° C. to obtain a powder.

### 4) Calcination (Step S40)

The powder was subjected to calcination at 600° C. to prepare composite particles including a carbon coating formed on the lithium-transition metal oxide particles and a CNT coating formed on the carbon coating.

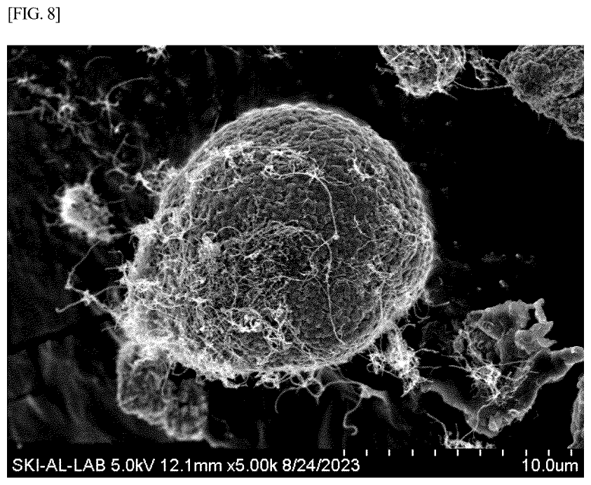

FIG. 8 is an FE-SEM image of the composite particles according to Example 1.

Referring to FIG. 8, the CNT coating was formed on the surface of the composite particles.

### (2) Manufacture of a Lithium Secondary Battery

A lithium secondary battery was manufactured using the composite particles as a cathode active material.

Specifically, the cathode active material, carbon black as a conductive agent, and PVDF as a binder were mixed in a mass ratio of 93:5:2 to prepare a cathode slurry, and then the slurry was applied to an aluminum current collector, followed by drying and pressing the same, to prepare a cathode.

Lithium metal was used as an anode.

The cathode and anode prepared as described above were each notched into circular shapes having diameters of Φ14 and Φ16, respectively, and laminated with a separation membrane (polyethylene, thickness: 13 μm) notched into Φ19 interposed between the cathode and the anode to form an electrode cell. ΦN (N is a positive number) may denote a circular shape having a diameter of N mm.

The electrode cell was placed in a coin cell outer case having a diameter of 20 mm and a height of 1.6 mm, followed by electrolyte injection and assembly. Thereafter, aging was carried out for 12 hours or more to allow the electrolyte to be impregnated into the electrode.

A 1M LiPF6 solution prepared using a mixed solvent of EC/EMC (30/70; volume ratio) was used as the electrolyte.

Formation charging and discharging were performed on the secondary battery manufactured as described above (charging conditions: CC-CV 0.1C 4.3V 0.005C CUT-OFF, discharging condition: CC 0.1C 3.0V CUT-OFF).

### Examples 2 to 5

Composite particles and lithium secondary batteries were manufactured in the same manner as in Example 1, except that the content of the dopamine compound (dopamine hydrochloride) based on the number of moles of the lithium-transition metal oxide particles was adjusted as described in Table 1 below.

### Comparative Example 1

Composite particles and a lithium secondary battery were manufactured in the same manner as in Example 1, except that the CNT coating (steps S30 and S40) was formed directly on the lithium-transition metal oxide particles without forming a polydopamine coating, and the calcination was carried out at 500° C.

### Comparative Examples 2 and 3

Composite particles and lithium secondary batteries were manufactured in the same manner as in Example 1, except that the content of the dopamine compound (dopamine hydrochloride) based on the number of moles of the lithium-transition metal oxide particles was adjusted as described in Table 1 below, and the calcination was carried out at 500° C.

### Comparative Example 4

Composite particles and a lithium secondary battery were manufactured in the same manner as in Example 1, except that the preliminary composite particles were used as the cathode active material without performing CNT mixing and calcination.

### Comparative Example 5

Composite particles and lithium secondary batteries were manufactured in the same manner as in Example 1, except that the preliminary composite particles were subjected to calcination without performing CNT mixing and used as cathode active materials.

### Experimental Example

### (1) Thermogravimetric Analysis (TGA)

Samples were separately collected for the preliminary composite particles and composite particles prepared in the above-described examples and comparative examples.

Each of the preliminary composite particle sample and the composite particle sample was placed in a TGA (Discovery/Q500, TA instruments), heated to 800° C. at a rate of 10° C./min, and the mass loss was measured.

The mass loss represents the percentage reduction in the mass of the sample after heating to 800° C. relative to the mass of the sample after heating to 200° C., and was calculated according to the following equation.

Mass loss (wt %)=100×(Mass of sample after heating to 200° C.−Mass of sample after heating to 800° C.)/(Mass of sample after heating to 200° C.)

Upon heating to 200° C., moisture and other impurities were removed, and upon further heating above 200° C., the coating material was decomposed and removed.

The mass loss of the composite particle sample was defined as the first mass loss, and the mass loss of the preliminary composite particle sample was defined as the second mass loss, and then the content of the CNT coating relative to the total weight of the composite particle was evaluated by subtracting the second mass loss from the first mass loss.

### (2) Measurement of Initial Discharge Capacity

After formation charging and discharging, the lithium secondary batteries of the above-described examples and comparative examples were charged (CC-CV 0.1C 4.3V 0.05C CUT-OFF) and discharged (CC 0.1C 2.5V CUT-OFF) once each at room temperature (25° C.), and the initial discharge capacity was measured.

### (3) E Valuation of Capacity Retention Rate (100th Cycle)

For the lithium secondary batteries of the above-described examples and comparative examples, charging (CC-CV 0.5C 4.3V 0.05C CUT-OFF) and discharging (CC 1.0C 2.5V CUT-OFF) were repeated 100 times, and the discharge capacity at 100 cycles was divided by the discharge capacity at 1 cycle and multiplied by 100 to evaluate the capacity retention rate.

### (4) Measurement of 5C Discharge Capacity and 10C Discharge Capacity

The lithium secondary batteries of the above-described examples and comparative examples were charged (CC-CV 0.1C 4.3V 0.05C CUT-OFF) and discharged (CC 5C 3.0V CUT-OFF) at room temperature (25° C.), and the discharge capacity was measured. Then, the measured discharge capacity was evaluated as the 5C discharge capacity.

The lithium secondary batteries of the above-described examples and comparative examples were charged (CC-CV 0.1C 4.3V 0.05C CUT-OFF) and discharged (CC 10C 2.5V CUT-OFF) at room temperature (25° C.), and the discharge capacity was measured. Then, the measured discharge capacity was evaluated as the 10C discharge capacity.

The measurement and evaluation results are shown in Tables 1 and 2 below.

TABLE 1

| | | | TGA | | |
|---|---|---|---|---|---|
| | Dopamine | | | | CNT |
| | compound | Calcination | First | Second | coating |
| | content | temperature | mass loss | mass loss | content |
| | (mol %) | (° C.) | (wt %) | (wt %) | (wt %) |
| Example 1 | 10 | 600 | 9.22 | 7.56 | 1.66 |
| Example 2 | 6 | 600 | 4.10 | 3.28 | 0.82 |
| Example 3 | 8 | 600 | 7.04 | 5.81 | 1.23 |
| Example 4 | 15 | 600 | 12.74 | 10.23 | 2.51 |
| Example 5 | 19 | 600 | 14.55 | 11.45 | 3.10 |
| Comparative | 0 | 500 | 0.09 | 0.02 | 0.07 |
| Example 1 | | | | | |
| Comparative | 5 | 500 | 3.84 | 3.11 | 0.73 |
| Example 2 | | | | | |
| Comparative | 20 | 500 | 15.40 | 12.27 | 3.13 |
| Example 3 | | | | | |
| Comparative | 10 | — | 9.18 | — | — |
| Example 4 | | | | | |
| Comparative | 10 | 600 | 9.19 | — | — |
| Example 5 | | | | | |

TABLE 2

| | Initial | | 5 C | 10 C |
|---|---|---|---|---|
| | discharge | Capacity | discharge | discharge |
| | capacity | retention rate | capacity | capacity |
| | (mAh/g) | (%, 100th cycle) | (mAh/g) | (mAh/g) |
| Example 1 | 213 | 93 | 208 | 198 |
| Example 2 | 216 | 84 | 199 | 186 |
| Example 3 | 215 | 89 | 203 | 191 |
| Example 4 | 205 | 94 | 202 | 187 |
| Example 5 | 191 | 96 | 195 | 180 |
| Comparative | 217 | 73 | 191 | 172 |
| Example 1 | | | | |
| Comparative | 216 | 81 | 198 | 180 |
| Example 2 | | | | |
| Comparative | 188 | 96 | 193 | 178 |
| Example 3 | | | | |
| Comparative | 197 | 84 | 187 | 167 |
| Example 4 | | | | |
| Comparative | 211 | 91 | 193 | 178 |
| Example 5 | | | | |

Referring to Tables 1 and 2, in the examples, where the CNT coating content measured through TGA was 0.8 wt % to 3.1 wt % based on the total weight of the composite particles and the input amount of the dopamine compound was 6 mol % to 19 mol % based on the number of moles of the lithium-transition metal oxide particles, the initial discharge capacity, capacity retention rate, 5C discharge capacity, and 10C discharge capacity were improved compared to the comparative examples.

Although the CNT input amount (4 wt % based on the weight of the preliminary composite particles) of the examples and Comparative Examples 1 to 3 was the same, the capacity, cycle life characteristics and power characteristics were improved in the examples compared to the comparative examples depending on the presence of the polydopamine coating and the input amount of the dopamine compound.

### DESCRIPTION OF REFERENCE NUMERALS

100: Cathode
105: Cathode current collector
107: Cathode lead
110: Cathode active material layer
120: A node active material layer
125: A node current collector
127: A node lead
130: A node
140: Separation membrane
150: Electrode assembly
160: Case

What is claimed is:

1. A cathode active material for a lithium secondary battery comprising:
lithium-transition metal oxide particles;
a carbon coating disposed on the lithium-transition metal oxide particles; and
composite particles comprising a carbon nanotube (CNT) coating formed on the carbon coating,
wherein a content of the CNT coating measured through thermogravimetric analysis (TGA) is 0.8% by weight to 3.1% by weight based on a total weight of the composite particles.

2. The cathode active material for a lithium secondary battery according to claim 1, wherein the content of the CNT coating is 1.23% by weight to 2.51% by weight based on the total weight of the composite particles.

3. The cathode active material for a lithium secondary battery according to claim 1, wherein the carbon coating is derived from polydopamine.

4. The cathode active material for a lithium secondary battery according to claim 1, wherein the lithium-transition metal oxide particles comprise nickel, and
a molar ratio of nickel included in the lithium-transition metal oxide particles based on the total number of moles of metals excluding lithium in the lithium-transition metal oxide particles is 0.8 or more.

5. A lithium secondary battery comprising:
the cathode comprising the cathode active material for a lithium secondary battery according to claim 1; and
an anode disposed to face the cathode.

6. A method of preparing a cathode active material for a lithium secondary battery comprising:
preparing lithium-transition metal oxide particles;
mixing the lithium-transition metal oxide particles with a dopamine compound in an amount of 6 mol % to 19 mol % based on the number of moles of the lithium-transition metal oxide particles to form preliminary composite particles comprising a polydopamine coating formed on the lithium-transition metal oxide particles;
forming a mixture of the preliminary composite particles and carbon nanotubes (CNTs); and
calcining the mixture to prepare composite particles comprising a carbon coating formed on the lithium-transition metal oxide particles and a CNT coating formed on the carbon coating,
wherein a content of the CNT coating measured through thermogravimetric analysis (TGA) is 0.8% by weight to 3.1% by weight based on a total weight of the composite particles.

7. The method of preparing a cathode active material for a lithium secondary battery according to claim 6, wherein covalent bonds are formed between the polydopamine coating and the CNTs in the mixture of the preliminary composite particles and the CNTs.

8. The method of preparing a cathode active material for a lithium secondary battery according to claim 6, wherein the polydopamine coating is carbonized during the calcination to form the carbon coating.

9. The method of preparing a cathode active material for a lithium secondary battery according to claim 6, wherein the calcination is performed at 400° C. to 800° C.

10. The method of preparing a cathode active material for a lithium secondary battery according to claim 6, wherein the dopamine compound comprises dopamine hydrochloride.

11. The method of preparing a cathode active material for a lithium secondary battery according to claim 6, wherein a content of the dopamine compound mixed with the lithium-transition metal oxide particles is 8 mol % to 15 mol % based on the number of moles of the lithium-transition metal oxide particles.

12. The method of preparing a cathode active material for a lithium secondary battery according to claim 6, wherein the content of the CNT coating is calculated by subtracting the carbon content of the preliminary composite particles measured through TGA from the carbon content of the composite particles measured through TGA.

13. The method of preparing a cathode active material for a lithium secondary battery according to claim 6, wherein the lithium-transition metal oxide particles are formed by reacting a lithium precursor with a transition metal precursor.
